(19) United States
(12) Patent Application Publication
(10) Pub. No.: US 2026/0307405 A1
(43) Pub. Date: Oct. 8, 2026

(54) PRINTING APPARATUS

(71) Applicant: Konica Minolta, Inc., Tokyo (JP)

(72) Inventor: Satoshi Tagami, Tokyo (JP)

(73) Assignee: Konica Minolta, Inc., Tokyo (JP)

(21) Appl. No.: 19/569,655

(22) Filed: Mar. 17, 2026

(30) Foreign Application Priority Data
Apr. 2, 2025 (JP) 2025-061201

(51) Int. Cl. B41J 13/00; B41J 2/21; B41J 3/44; B41J 11/00; B41J 13/22; H04N 1/00

(52) U.S. Cl. CPC B41J 13/0027; B41J 2/2135; B41J 3/44; B41J 11/00212; B41J 11/00214; B41J 13/0036; B41J 13/223; H04N 1/00798; H04N 2201/0081

(57) ABSTRACT

Provided is a printing apparatus that includes: a conveyor; an image former; an image reader; and a controller. In a case where a step of circulating and conveying a recording medium is repeated a plurality of times in a state in which the recording medium is held by a holder, in a first step, an image is formed on the recording medium while the recording medium is circulated and conveyed at a first conveyance speed, and in a second step after the first step ends, the image formed on the recording medium is read while the recording medium is circulated and conveyed at a second conveyance speed slower than the first conveyance speed.

### CROSS REFERENCE TO RELATED APPLICATIONS

Japanese Patent Application No. 2025-061201, filed on Apr. 2, 2025, including description, claims, drawings, and abstract the entire disclosure is incorporated herein by reference in its entirety.

### BACKGROUND

### Technological Field

The present invention relates to a printing apparatus.

### Description of Related Art

For example, Japanese Patent Application Laid-Open No. 2015-9463 discloses a related art of a printing apparatus such as an inkjet printing apparatus. The printing apparatus described in Japanese Patent Application Laid-Open No. 2015-9463 includes a conveyor that conveys a recording medium in the conveyance direction thereof in a state in which the recording medium is held. In addition, the printing apparatus described in Japanese Patent Application Laid-Open No. 2015-9463 further includes: an image former that forms an image by ejecting ink onto a recording medium during conveyance; and an image reader that reads the image formed on the recording medium during conveyance to generate a scanned image (captured image).

### SUMMARY

Incidentally, in a case where an image formed on a recording medium includes a pattern image used for adjustment of an image former, there is a demand for obtaining a scanned image with a high resolution by causing an image reader to read the pattern image. In order to meet this demand, the following method is adopted.

First, an image former forms an image including a pattern image on a recording medium while a conveyor conveys the recording medium at a normal conveyance speed. Subsequently, the recording medium is once discharged from the conveyor and is set on a placement tray or the like on a conveying-in side of the conveyor so that the recording medium is conveyed into the conveyor again. Thereafter, an image reader reads the pattern image included in the image formed on the recording medium while the conveyor conveys the recording medium at a conveyance speed slower than the normal conveyance speed, thereby generating a scanned image with a high resolution.

In a case where the above-described method is adopted, there is a problem in that the recording medium on which the image including the pattern image has been formed has to be manually set on the placement tray or the like on the conveying-in side of the conveyor, which takes labor and time, and decreases the processing efficiency of the printing apparatus. Note that, this problem similarly arises in a case where an image other than a pattern image is read by an image reader to obtain a scanned image with a high resolution.

Given the above, an object of the present invention is to provide a printing apparatus capable of obtaining a scanned image with a high resolution by reading an image formed on a recording medium while increasing the processing efficiency of the printing apparatus.

An aspect of a printing apparatus in the present invention includes:

a conveyor that circulates and conveys a recording medium in a state in which the recording medium is held by a holder;

an image former that forms an image by ejecting ink onto the recording medium during conveyance;

an image reader that reads an image formed on the recording medium during the conveyance to generate a scanned image; and

a hardware processor that functions as a controller that controls the conveyor, the image former, and the image reader, in a case where a step of circulating and conveying the recording medium is repeated a plurality of times in the state in which the recording medium is held by the holder, such that in a first step, the image is formed on the recording medium while the recording medium is circulated and conveyed at a first conveyance speed, and that in a second step after the first step ends, the image formed on the recording medium is read while the recording medium is circulated and conveyed at a second conveyance speed slower than the first conveyance speed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic front view of an inkjet printing apparatus according to the present embodiment;

FIG. 2A is a conceptual diagram illustrating how a pattern image is formed in a margin portion of a recording medium;

FIG. 2B is a conceptual diagram illustrating how the pattern image is formed in a portion other than the margin portion of the recording medium;

FIG. 3 is a control block diagram of the inkjet printing apparatus according to the present embodiment; and

FIG. 4 is a flowchart illustrating a flow of operations of the inkjet printing apparatus according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

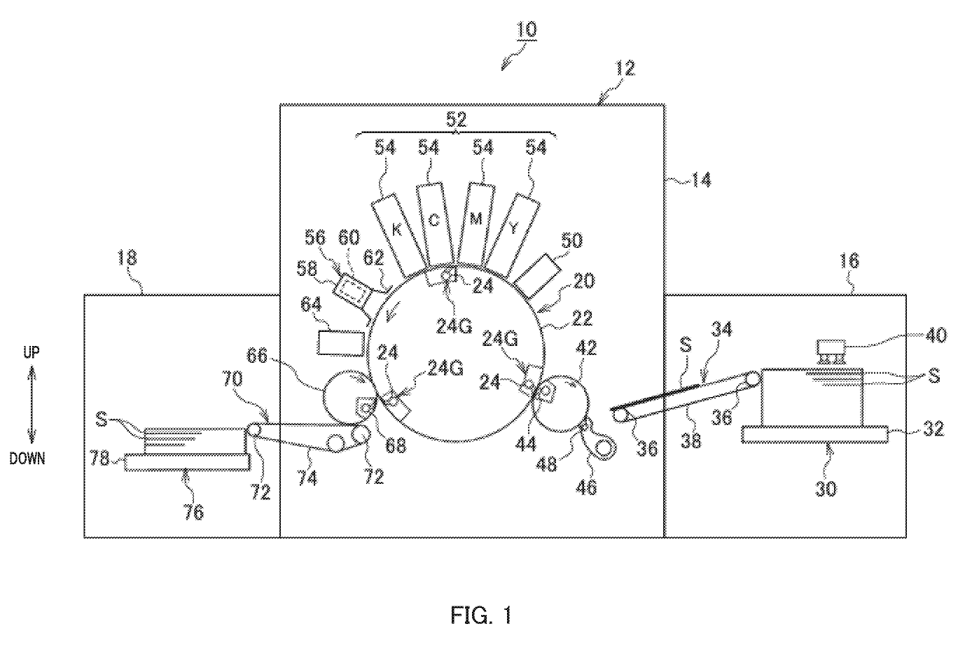

Hereinafter, the present embodiment will be described with reference to the accompanying drawings. In the present embodiment, the conveyance direction refers to a direction in which a recording medium is conveyed. The downstream side refers to the downstream side in the conveyance direction, and the upstream side refers to the upstream side in the conveyance direction. The conveyance width direction is a direction orthogonal to the conveyance direction and is the front-rear direction in FIG. 1.

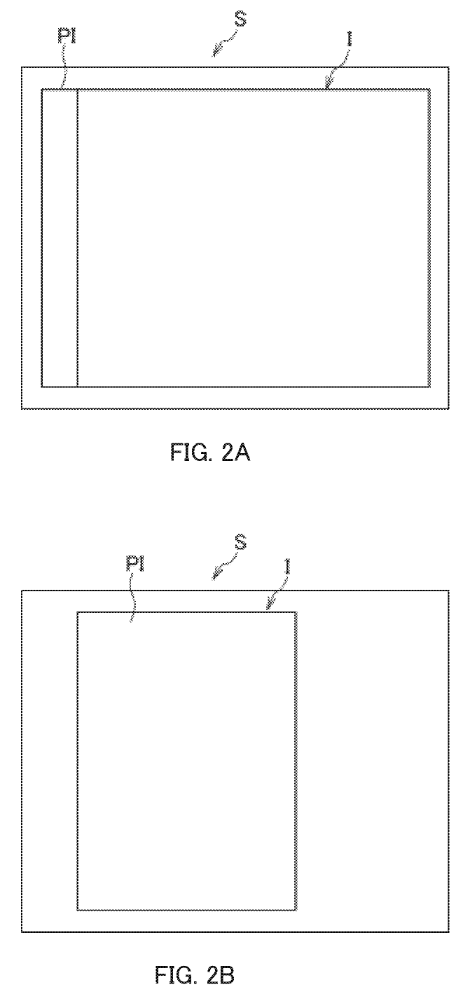

The overall configuration of an inkjet printing apparatus 10 according to the present embodiment will be described with reference to FIGS. 1-2B. FIG. 1 is a schematic front view of the inkjet printing apparatus 10 according to the present embodiment. FIG. 2A is a conceptual diagram illustrating how a pattern image PI is formed in a margin portion of a recording medium S. FIG. 2B is a conceptual diagram illustrating how the pattern image PI is formed in a portion other than the margin portion of the recording medium S.

As illustrated in FIG. 1, the inkjet printing apparatus 10 according to the present embodiment is a single-pass printing apparatus that performs image formation (printing) on the recording medium S having a sheet-like shape while conveying the recording medium S in the conveyance direction. As the recording medium S, in addition to paper such as plain paper and coated paper, various media such as fabric and a resin film can be used.

The inkjet printing apparatus 10 includes a printing apparatus main body 12 extending in the left-right direction in FIG. 1. The printing apparatus main body 12 includes: a center frame 14; a first side frame 16 disposed on one side of the center frame 14; and a second side frame 18 disposed on the other side of the center frame 14.

As illustrated in FIG. 1, the inkjet printing apparatus 10 includes a conveyor 20 that circulates and conveys the recording medium S in the conveyance direction, and the conveyor 20 is provided in the center frame 14. The conveyor 20 includes a printing cylinder 22 rotatably provided in the center frame 14, and the printing cylinder 22 rotates while carrying the recording medium S.

The printing cylinder 22 includes a plurality of holding claws 24, which holds a leading end portion of the recording medium S, on the outer periphery surface side of the printing cylinder 22, and the plurality of holding claws 24 corresponds to the holder that holds the recording medium S. The plurality of holding claws 24 is divided into a plurality of (for example, three) claw groups 24G, and the plurality of claw groups 24G is arranged at equal intervals on the outer periphery surface of the printing cylinder 22. The plurality of holding claws 24 (only one holding claw 24 is illustrated) of each claw group 24G is arranged at intervals along the conveyance width direction.

The outer periphery surface of the printing cylinder 22 serves as a conveyance surface of the conveyor 20, and a plurality of adsorption sections (not illustrated) that adsorbs the recording medium S is provided on the outer periphery surface of the printing cylinder 22. The adsorption method of the plurality of adsorption sections may be any one of suction adsorption and electrostatic adsorption.

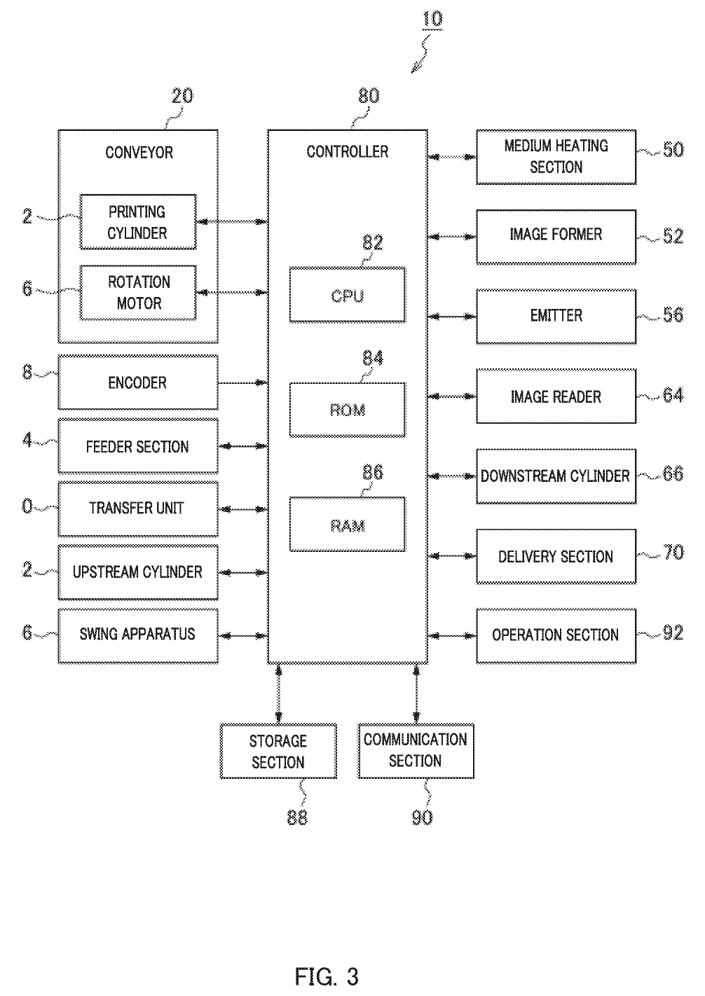

The conveyor 20 includes a rotation motor 26 (see FIG. 3) as a drive source that rotates the printing cylinder 22, and the rotation motor 26 is provided at an appropriate position of the center frame 14. The printing cylinder 22 is rotated by driving of the rotation motor 26 in a state in which the leading end portion of the recording medium S is held by the plurality of holding claws 24 of any one of the claw groups 24G, and thus, the recording medium S is circulated and conveyed. The conveyor 20 circulates and conveys the recording medium S in the conveyance direction in a state in which the leading end portion of the recording medium S is held by the plurality of holding claws 24 of any one of the claw groups 24G.

An encoder 28 (see FIG. 3) that detects the number of rotations of the printing cylinder 22 is provided at an appropriate position on a rotation shaft (not illustrated) of the printing cylinder 22. The encoder 28 detects the number of rotations of the printing cylinder 22, thereby detecting the rotational speed of the printing cylinder 22 (the conveyance speed of the conveyor 20). In other words, the encoder 28 corresponds to the speed detector that detects the conveyance speed of the conveyor 20.

As illustrated in FIG. 1, the inkjet printing apparatus 10 includes a first stacking section 30 for stacking a plurality of recording media S, and the first stacking section 30 is provided in the first side frame 16. The first stacking section 30 is disposed on the conveying-in side of the conveyor 20. The first stacking section 30 includes a placement tray 32 for placing the recording medium S, and the placement tray 32 is provided in the first side frame 16 so as to be movable up and down. The placement tray 32 is configured to move up and down according to the amount of recording media S to be placed, and the uppermost recording medium S is held at a predetermined height position.

As illustrated in FIG. 1, the inkjet printing apparatus 10 includes a feeder section 34 that supplies the recording medium S, which has been transferred from the side of the placement tray 32, to the side of the conveyor 20 (the conveyance direction). The feeder section 34 is provided from the first side frame 16 to the center frame 14. The feeder section 34 is disposed between the printing cylinder 22 and the first stacking section 30. The feeder section 34 includes: a plurality of support rollers 36, which is capable of rotating; and a belt 38 having an endless shape, which is provided so as to be wound around the plurality of support rollers 36. In addition, any one of the support rollers 36 is interlocked with and coupled to an output shaft of the rotation motor 26.

As illustrated in FIG. 1, the inkjet printing apparatus 10 includes a transfer unit 40 that transfers the uppermost recording medium S stacked on the placement tray 32 to the feeder section 34. The transfer unit 40 is provided above the first stacking portion 30 in the first side frame 16. In addition, a plurality of registration sections (not illustrated) that positions the recording medium S is provided on the downstream end side of the feeder section 34, and the plurality of registration sections is arranged at intervals along the conveyance width direction. Each registration section includes an abutment surface that can abut on the leading end surface of the recording medium S, and is configured to be swingable in the up-down direction.

The belt 38 is circulated by the rotation of the plurality of support rollers 36, thereby supplying the recording medium S, which has been transferred by the transfer unit 40, to the side of the printing cylinder 22. Then, the recording medium S is positioned at a predetermined position on the feeder section 34 such that the leading end surface of the recording medium S abuts on the abutment surface of the plurality of registration sections and becomes parallel to the conveyance width direction.

As illustrated in FIG. 1, the inkjet printing apparatus 10 includes an upstream cylinder 42 that delivers the recording medium S to the printing cylinder 22, and the upstream cylinder 42 is rotatably provided on the upstream side of the printing cylinder 22 in the center frame 14. The upstream cylinder 42 is disposed close to the printing cylinder 22, and rotates while carrying a recording medium S. The upstream cylinder 42 is configured to rotate in the direction opposite to the rotation direction of the printing cylinder 22 in conjunction with the rotation of the printing cylinder 22. The diameter of the upstream cylinder 42 is one third of the diameter of the printing cylinder 22, and the upstream cylinder 42 is configured to perform one rotation when the printing cylinder 22 performs a one-third rotation.

The upstream cylinder 42 includes a plurality of holding claws 44 (only one holding claw 44 is illustrated), which holds the leading end portion of the recording medium S, on the outer circumferential surface side of the upstream cylinder 42, and the plurality of holding claws 44 is arranged at intervals in the conveyance width direction. The plurality of holding claws 44 of the upstream cylinder 42 and the plurality of holding claws 24 of any one of the claw groups 24G of the printing cylinder 22 perform a gripping change operation of the recording medium S in a state of being close to each other. The plurality of holding claws 24 of any one of the claw groups 24G in the printing cylinder 22 receives the leading end portion of the recording medium S from the plurality of holding claws 44 of the upstream cylinder 42 and holds the leading end portion of the recording medium S.

As illustrated in FIG. 1, the inkjet printing apparatus 10 includes a swing apparatus 46 that delivers the recording medium S from the side of the feeder section 34 to the upstream cylinder 42. The swing apparatus 46 is provided to be swingable between the upstream cylinder 42 and the feeder section 34 in the center frame 14. A plurality of holding claws 48 (only one holding claw 48 is illustrated) that holds the leading end portion of the recording medium S is provided at a leading end portion of the swing apparatus 46, and the plurality of holding claws 48 is arranged at intervals in the conveyance width direction. Swinging the swing apparatus 46 causes the plurality of holding claws 48 to move between a position corresponding to the downstream end of the feeder section 34 (a position at which the plurality of holding claws 48 approaches the downstream end of the feeder section 34) and a position corresponding to the upstream cylinder 42.

After the plurality of holding claws 48 of the swing apparatus 46 is located at the position corresponding to the downstream end of the feeder section 34, the plurality of holding claws 48 of the swing apparatus 46 receives the leading end portion of the recording medium, which has been positioned at the predetermined position on the feeder section 34, and holds the leading end portion of the recording medium. Note that, immediately after the plurality of holding claws 48 of the swing apparatus 46 holds the leading end portion of the recording medium S, the plurality of registration sections swings in the down direction and separates from the recording medium S.

After the plurality of holding claws 48 of the swing apparatus 46 is positioned at the position corresponding to the upstream cylinder 42, the plurality of holding claws 48 of the swing apparatus 46 and the plurality of holding claws 44 of the upstream cylinder 42 perform a gripping change operation of the recording medium S in a state of being close to each other. The plurality of holding claws 44 of the upstream drum 42 receives the leading end portion of the recording medium S from the plurality of holding claws 48 of the swing apparatus 46 and holds the leading end portion of the recording medium S.

As illustrated in FIG. 1, the inkjet printing apparatus 10 includes a medium heating section 50 that heats the recording medium S carried on the printing cylinder 22, and the medium heating section 50 is provided on the downstream side of the upstream cylinder 42 in the center frame 14. The medium heating section 50 is disposed to face the outer periphery surface of the printing cylinder 22. The medium heating section 50 includes, for example, an infrared ray heater or the like, and heats the printing cylinder 22 and the recording medium S such that the recording medium S conveyed by the printing cylinder 22 has a temperature within a predetermined range.

As illustrated in FIGS. 1-2B, the inkjet printing apparatus 10 includes an image former 52 that forms an image I by ejecting ink onto the recording medium S during conveyance, and the image former 52 is provided on the downstream side of the medium heating section 50 in the center frame 14. The image former 52 includes a plurality of inkjet sections 54 that ejects inks of four colors of yellow (Y), magenta (M), cyan (C), and black (K) to the recording medium S carried on the printing cylinder 22. The plurality of inkjet sections 54 corresponding to the inks of the four colors of Y, M, C, and K is arranged at intervals along the conveyance direction.

Each of the inkjet sections 54 includes a plurality of inkjet heads (not illustrated) that ejects ink onto the recording medium S, and a plurality of nozzles (not illustrated) for ejecting ink are formed at a leading end portion of each inkjet head. The plurality of inkjet heads is disposed, for example, in a staggered pattern along the conveyance width direction. In other words, each of the inkjet sections 54 constitutes a line head including a plurality of inkjet heads.

Ultraviolet curable ink (UV ink) that is cured (solidified) by the emission of ultraviolet rays, which are one type of energy rays, is used as the ink that is ejected from the inkjet section 54. In particular, UV gel ink, which undergoes a phase change between a gel state and a sol state (liquid state) depending on the temperature, is used among UV inks. Note that, in addition to the UV ink, any other ink having a property of being dried or cured by energy rays such as infrared rays or an electron beam may also be used as the ink that is ejected from the inkjet section 54.

As illustrated in FIGS. 1 and 2A, the image former 52 forms, based on a composite image obtained by combining image data included in a print job and image data for a pattern image, the image I including the pattern image PI on the recording medium S. In this case, the pattern image PI is usually formed in a margin portion of the recording medium S. In addition, as illustrated in FIGS. 1 and 2B, the image former 52 may form the pattern image PI in a portion other than the margin portion of the recording medium S based on the image data for a pattern image. In this case, the image I formed on the recording medium S is only the pattern image PI.

The pattern image PI refers to an image used for adjustment of the image former 52. Examples of the pattern image PI include a shading image for performing shading correction, a gamma image for performing gamma correction, an adjustment image for adjusting the positional relationship between the plurality of inkjet heads, and a test image for detecting a nozzle failure.

As illustrated in FIGS. 1-2B, the inkjet printing apparatus 10 includes an emitter 56 that emits ultraviolet rays to the recording medium S during conveyance, on which the image I has been formed, and the emitter 56 is provided on the downstream side of the image former 52 in the center frame 14. The emitter 56 is disposed to face the outer periphery surface of the printing cylinder 22. By emitting ultraviolet rays from the emitter 56 to the recording medium S, the ink on the recording medium S can be cured to fix the image I on the recording medium S.

The emitter 56 includes an emitter main body 58, which is provided on the downstream side of the image former 52 in the center frame 14, and a light source 60, which is provided in the emitter main body 58 and emits ultraviolet rays. The emitter 56 includes a shielding member 62 which is provided in a lower portion of the emitter main body 58 and suppresses leakage of ultraviolet rays. Note that, in a case where another ink is used as the ink that is ejected from the inkjet section 54, the emitter 56 emits energy rays corresponding to the properties of the other ink.

As illustrated in FIGS. 1-2B, the inkjet printing apparatus 10 includes an image reader 64 that reads the image I formed on the recording medium S during conveyance. The image reader 64 is provided on the downstream side of the emitter 56 in the center frame 14, and the image reader 64 is disposed close to the emitter 56. The image reader 64 is disposed to face the outer periphery surface of the printing cylinder 22. The image reader 64 generates a scanned image by reading the image I formed on the recording medium S during conveyance. The image reader 64 may generate a scanned image by reading only the pattern image PI in the image I formed on the recording medium S during conveyance. The image reader 64 includes a plurality of imaging elements such as a plurality of charge-coupled device (CCD) image sensors or a plurality of complementary metal oxide semiconductor (CMOS) image sensors arranged along the conveyance width direction.

As illustrated in FIG. 1, the inkjet printing apparatus 10 includes a downstream cylinder 66 that receives the recording medium S on which an image formation has been performed (printing has been performed) from the printing cylinder 22, and the downstream cylinder 66 is rotatably provided on the downstream side of the printing cylinder 22 in the center frame 14. The downstream cylinder 66 is disposed close to the printing cylinder 22, and rotates while carrying the recording medium S on which an image formation has been performed. The downstream cylinder 66 is configured to rotate in the direction opposite to the rotation direction of the printing cylinder 22 in conjunction with the rotation of the printing cylinder 22. The diameter of the downstream cylinder 66 is one third of the diameter of the printing cylinder 22, and the downstream cylinder 66 is configured to perform one rotation when the printing cylinder 22 performs a one-third rotation.

The downstream cylinder 66 includes a plurality of holding claws 68 (only one holding claw 68 is illustrated), which holds the leading end portion of the recording medium S on which an image formation has been performed, on the outer periphery surface side of the downstream cylinder 66, and the plurality of holding claws 68 is arranged at intervals in the conveyance width direction. The plurality of holding claws 68 of the downstream cylinder 66 and the plurality of holding claws 24 of any one of the claw groups 24G of the printing cylinder 22 perform a gripping change operation of the recording medium S. The plurality of holding claws 68 of the downstream cylinder 66 receives the leading end portion of the recording medium S, on which an image formation has been performed, from the plurality of holding claws 24 of any one of the claw groups 24G of the printing cylinder 22 and holds the leading end portion of the recording medium S.

As illustrated in FIG. 1, the inkjet printing apparatus 10 includes a delivery section 70 that conveys the recording medium S which has been fed out from the downstream cylinder 66 and on which an image formation has been performed, and the delivery section 70 is provided from the center frame 14 to the second side frame 18. The delivery section 70 includes: a plurality of support rollers 72, which is capable of rotating; and a belt 74 having an endless shape, which is provided so as to be wound around the plurality of support rollers 72. In addition, any one of the support rollers 72 is interlocked with and coupled to an output shaft of the rotation motor 26. By circulating the belt 74 by the rotation of the plurality of support rollers 72, the recording medium S on which an image formation has been performed and which has been fed out from the downstream cylinder 66 is conveyed in the conveyance direction.

As illustrated in FIG. 1, the inkjet printing apparatus 10 includes a second stacking section 76 for stacking a plurality of recording media S on which an image formation has been performed, and the second stacking section 76 is provided in the second side frame 18. The second stacking section 76 is disposed on the conveying-out side of the conveyor 20. The second stacking section 76 includes a placement tray 78 for placing the recording medium S on which an image formation has been performed. The second stacking section 76 accommodates the recording medium S until the user takes out the recording medium S from the placement tray 78.

The control configuration of the inkjet printing apparatus 10 according to the present embodiment will be described with reference to FIGS. 1-3. FIG. 3 is a control block diagram of the inkjet printing apparatus 10 according to the present embodiment.

As illustrated in FIG. 3, the inkjet printing apparatus 10 includes a controller 80 that controls the printing cylinder 22, the rotation motor 26, the feeder section 34, the upstream cylinder 42, the swing apparatus 46, the image former 52, the emitter 56, the image reader 64, the downstream cylinder 66, and the like. The controller 80 plays a role in governing control of the entire inkjet printing apparatus 10. The controller 80 includes a central processing unit (CPU) 82, a read only memory (ROM) 84, and a random access memory (RAM) 86. A storage section 88 and a communication section 90 are connected to the controller 80.

The CPU 82 comprehensively controls the entire operation of the inkjet printing apparatus 10. The CPU 82 reads various kinds of control programs and setting data stored in the ROM 84, stores the read programs and setting data in the RAM 86, and executes the programs to perform various kinds of arithmetic processing. In addition, the RAM 86 provides a working memory space to the CPU 82 and stores temporary data. The RAM 86 may include a non-volatile memory.

When performing various kinds of arithmetic processing, the CPU 82 refers to various kinds of data stored in the storage section 88. The storage section 88 is constituted by, for example, a non-volatile semiconductor memory or a hard disk drive. The storage section 88 may store image data for a pattern image, a plurality of second conveyance speeds to be described later, and the like.

The controller 80 transmits and receives various kinds of data to and from an external apparatus (for example, a computer) connected to a network such as a local area network (LAN) or a wide area network (WAN) via the communication section 90. For example, the controller 80 receives a print job transmitted from the external apparatus, and controls the image former 52 based on image data included in the print job. The communication section 90 is constituted by, for example, a communication control card such as a LAN card.

The controller 80 generates composite image data by combining image data included in a print job and image data for a pattern image stored in the storage section 88. The controller 80 controls the image former 52 based on the composite data such that the image I including the pattern image PI is formed on the recording medium S (see FIG. 2A). The controller 80 may control the image former 52 based on the image data for a pattern image such that the pattern image PI is formed in a portion other than a margin portion of the recording medium S (see FIG. 2B).

An operation section 92 that receives an operation input from the user is connected to the controller 80, and the operation section 92 outputs operation information corresponding to the operation input to the controller 80. The operation section 92 includes, for example, a touch screen (not illustrated) and various operation keys (not illustrated). In addition, an encoder 28 is connected to the controller 80, and the encoder 28 outputs a detection result thereof to the controller 80.

In a case where a step of circulating and conveying the recording medium S is repeated a plurality of times in a state in which the leading end portion of the recording medium S is held by the plurality of holding claws 24, the controller 80 controls the printing cylinder 22, the rotation motor 26, the image former 52, the emitter 56, and the image reader 64 as follows.

As illustrated in FIGS. 1-3, the controller 80 controls the rotation motor 26 and the image former 52 such that in a first step, the image I including the pattern image PI is formed on the recording medium S while the recording medium S is circulated and conveyed at a first conveyance speed. The controller 80 controls the rotation motor 26 and the emitter 56 such that in the first step, ultraviolet rays are emitted to the recording medium S on which the image I has been formed while the recording medium S is circulated and conveyed at the first conveyance speed. The first step is a step in which the recording medium S is being circulated and conveyed for the first circulation by the rotation of the printing cylinder 22 for the first rotation. The first conveyance speed is a speed equivalent to the normal conveyance speed.

The controller 80 controls the rotation motor 26 and the image reader 64 such that in a second step after the first step ends, the pattern image PI included in the image I formed on the recording medium S is read while the recording medium S is circulated and conveyed at a second conveyance speed. In addition, the controller 80 controls the emitter 56 such that in the second step, the emission of the ultraviolet rays is stopped. In other words, the controller 80 controls the rotation motor 26, the emitter 56, and the image reader 64 such that in the second step, the pattern image PI of the recording medium S is read in a state in which the emission of the ultraviolet rays is stopped while the recording medium S is circulated and conveyed at the second conveyance speed. The second step is a step in which the recording medium S is being circulated and conveyed for the second and subsequent circulations by the rotation of the printing cylinder 22 for the second and subsequent rotations. The second conveyance speed is a conveyance speed slower than the first conveyance speed (the normal conveyance speed).

Based on the user’s operation input received by the operation section 92, the controller 80 selects, from a plurality of second conveyance speeds stored in the storage section 88, a second conveyance speed corresponding to the resolution of a scanned image. The plurality of second conveyance speeds is, for example, a one-quarter speed of the normal conveyance speed, a half speed of the normal conveyance speed, and a one-eighth speed of the normal conveyance speed. For example, in a case where a scanned image of a resolution of 300 dpi is generated at the normal conveyance speed, the controller 80 selects, from the plurality of second conveyance speeds, the one-quarter speed of the normal conveyance speed when a scanned image of a resolution of 1200 dpi is acquired. The controller 80 selects, from the plurality of second conveyance speeds, the half speed of the normal conveyance speed when a scanned image of a resolution of 600 dpi is acquired. The controller 80 selects, from the plurality of second conveyance speeds, the one-eighth speed when a scanned image of a resolution of 2400 dpi is acquired.

The controller 80 determines, based on the detection result from the encoder 28, whether the entire region of the recording medium S has exited from an emission region of ultraviolet rays by the emitter 56 in the first step. In a case where the controller 80 determines that the entire region of the recording medium S has exited from the emission region of ultraviolet rays by the emitter 56, the controller 80 controls the rotation motor 26 such that the rotational speed of the printing cylinder 22 (the conveyance speed of the conveyor 20) is switched from the first conveyance speed to the selected second conveyance speed. In other words, the controller 80 controls the rotation motor 26 such that the rotational speed of the printing cylinder 22 is switched from the first conveyance speed to the selected second conveyance speed after the entire region of the recording medium S exits from the emission region of ultraviolet rays by the emitter 56.

The controller 80 controls the image reader 64 such that in the second step, the image I formed on the recording medium S is read on a condition that the conveyance speed of the conveyor 20 detected by the encoder 28 has become the selected second conveyance speed.

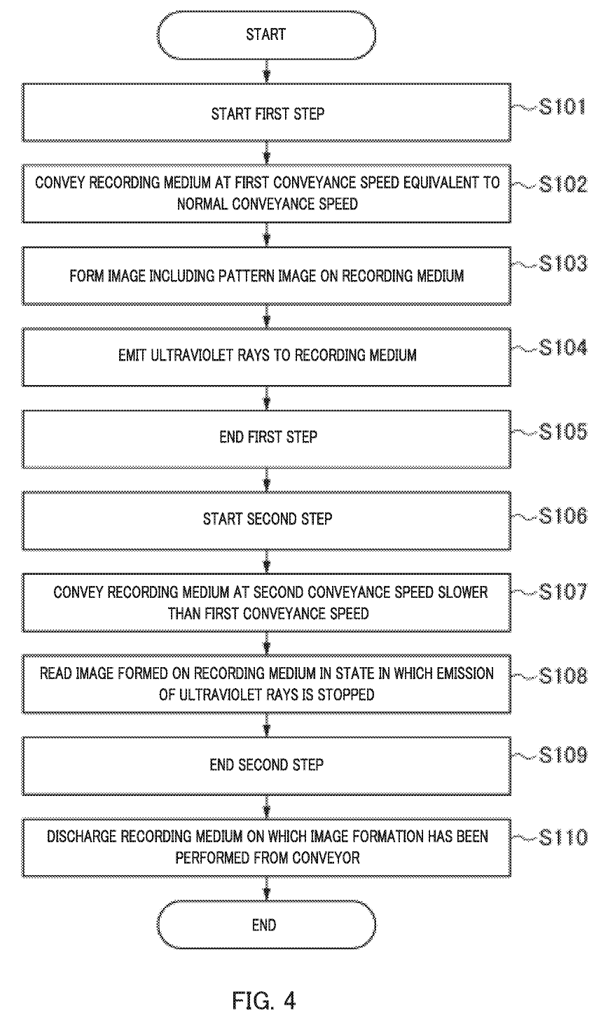

A flow of operations in a first control aspect of the inkjet printing apparatus 10 will be described with reference to FIGS. 1-4. FIG. 4 is a flowchart illustrating a flow of operations of the inkjet printing apparatus 10 according to the present embodiment.

As illustrated in FIGS. 1, 3, and 4, the first step is started when the plurality of holding claws 24 of the printing cylinder 22 receives the leading end portion of the recording medium S from the plurality of holding claws 44 of the upstream cylinder 42 and holds the leading end portion of the recording medium S (step S101 in FIG. 4). In addition, the controller 80 controls the rotation motor 26 such that the conveyance speed of the conveyor 20 becomes the first conveyance speed equivalent to the normal conveyance speed, thereby conveying the recording medium S at the first conveyance speed (step S102 in FIG. 4).

As illustrated in FIGS. 1-4, the controller 80 controls the image former 52 such that ink is ejected from the plurality of inkjet sections 54 onto the recording medium S during conveyance, thereby forming the image I including the pattern image PI on the recording medium S (step S103 in FIG. 4). Subsequently, the controller 80 controls the emitter 56 such that ultraviolet rays are emitted the recording medium S during conveyance (step S104 in FIG. 4). Thus, the image I is fixed onto the recording medium S, and the first step ends (step S105 in FIG. 4).

After the first step ends, the second step is started in a state in which the plurality of holding claws 24 of the printing cylinder 22 holds the leading end portion of the recording medium S (step S106 in FIG. 4). In addition, the controller 80 controls the rotation motor 26 such that the conveyance speed of the conveyor 20 becomes the second conveyance speed slower than the normal conveyance speed, thereby conveying the recording medium S at the second conveyance speed (step S107 in FIG. 4). Note that, the second step is started when the printing cylinder 22 enters the second rotation or after the printing cylinder 22 enters the second rotation.

In a state in which the controller 80 controls the emitter 56 such that the emission of ultraviolet rays is stopped, the controller 80 controls the image reader 64 such that the pattern image PI formed on the recording medium S during conveyance is read (step S108 in FIG. 4). Thus, the controller 80 acquires the scanned image from the image reader 64, and the second step ends (step S109 in FIG. 4).

After the second step ends, the plurality of holding claws 68 of the downstream cylinder 66 receives the leading end portion of the recording medium S, on which an image formation has been performed, from the plurality of holding claws 24 of the printing cylinder 22 and holds the leading end portion of the recording medium S, thereby discharging the recording medium S from the conveyor 20 (step S110 in FIG. 4).

According to the configuration of the inkjet printing apparatus 10 of the present embodiment, the controller 80 controls the rotation motor 26 and the image former 52 such that in the first step, the image I is formed on the recording medium S while the recording medium S is circulated and conveyed at the first conveyance speed. The controller 80 controls the rotation motor 26 and the image reader 64 such that in the second step after the first step ends, the pattern image PI included in the image I formed on the recording medium S is read while the recording medium S is circulated and conveyed at the second conveyance speed. For this reason, by repeating the step of circulating and conveying the recording medium S a plurality of times in a state in which the leading end portion of the recording medium S is held by the plurality of holding claws 24, the image reader 64 can read the pattern image PI formed on the recording medium S to generate a scanned image with a high resolution. In other words, without setting the recording medium S, on which the image I including the pattern image PI has been formed, on the placement tray 32 or the like on the conveying-in side of the conveyor 20, the image reader 64 can read the pattern image PI to generate a scanned image with a high resolution.

Accordingly, the inkjet printing apparatus 10 of the present embodiment makes it possible to read the pattern image PI formed on the recording medium S and obtain a scanned image with a high resolution while increasing the processing efficiency of the inkjet printing apparatus 10.

In addition, according to the configuration of the inkjet printing apparatus 10 according to the present embodiment, the controller 80 selects, from a plurality of second conveyance speeds, a second conveyance speed corresponding to the resolution of a scanned image. For this reason, the image reader 64 can read the pattern image PI to generate an optimum scanned image with a high resolution.

Accordingly, the inkjet printing apparatus 10 according to the present embodiment makes it possible to read the pattern image PI formed on the recording medium S to obtain an optimum scanned image with a high resolution.

In addition, according to the configuration of the inkjet printing apparatus 10 according to the present embodiment, the controller 80 controls the rotation motor 26 such that the rotational speed of the printing cylinder 22 is switched to the second conveyance speed after the entire region of the recording medium exits from the emission region of ultraviolet rays by the emitter 56. For this reason, ultraviolet rays can be substantially uniformly emitted to the entire region of the recording medium S, and the accuracy of the image I formed on the recording medium S can be stabilized.

Accordingly, the inkjet printing apparatus 10 of the present embodiment makes it possible to read the pattern image PI formed on the recording medium S to stably obtain a scanned image with a high resolution.

In addition, according to the configuration of the inkjet printing apparatus 10 according to the present embodiment, the controller 80 controls the emitter 56 and the like such that in the first step, ultraviolet rays are emitted to the recording medium S on which the image I has been formed while the recording medium S is circulated and conveyed at the first conveyance speed. The controller 80 controls the image reader 64 and the like such that in the second step, the pattern image PI included in the image I formed on the recording medium S is read while the recording medium S is circulated and conveyed at the second conveyance speed in a state in which the emission of ultraviolet rays is stopped. For this reason, in the second step, no leakage light of ultraviolet rays is incident on the side of the image reader 64, the image reader 64 can read the pattern image PI with a high accuracy to generate a scanned image with a high resolution, with a high accuracy.

Accordingly, the inkjet printing apparatus 10 of the present embodiment makes it possible to read the pattern image PI formed on the recording medium S with a high accuracy to obtain a scanned image with a high resolution, with a high accuracy.

In addition, according to the configuration of the inkjet printing apparatus 10 of the present embodiment, the controller 80 controls the image reader 64 such that in the second step, the image I formed on the recording medium S is read on a condition that the conveyance speed of the conveyor 20 has become the second conveyance speed. For this reason, the image reader 64 can read the pattern image PI to stably generate a scanned image with a high resolution.

Accordingly, the inkjet printing apparatus 10 of the present embodiment makes it possible to read the pattern image PI formed on the recording medium S to stably obtain a scanned image with a high resolution.

Although embodiments of the present invention have been described and illustrated in detail, it is clearly understood that the same is by way of illustration and example only and not limitation, the scope of the present invention should be interpreted by terms of the appended claims.

What is claimed is:

1. A printing apparatus, comprising:
a conveyor that circulates and conveys a recording medium in a state in which the recording medium is held by a holder;
an image former that forms an image by ejecting ink onto the recording medium during conveyance;
an image reader that reads an image formed on the recording medium during the conveyance to generate a scanned image; and
a hardware processor that functions as a controller that controls the conveyor, the image former, and the image reader, in a case where a step of circulating and conveying the recording medium is repeated a plurality of times in the state in which the recording medium is held by the holder, such that in a first step, the image is formed on the recording medium while the recording medium is circulated and conveyed at a first conveyance speed, and that in a second step after the first step ends, the image formed on the recording medium is read while the recording medium is circulated and conveyed at a second conveyance speed slower than the first conveyance speed.

2. The printing apparatus according to claim 1, wherein
the controller selects, from a plurality of the second conveyance speeds, the second conveyance speed corresponding to a resolution of the scanned image.

3. The printing apparatus according to claim 1, further comprising a speed detector that detects a conveyance speed of the conveyor, wherein
the controller controls the image reader such that in the second step, the image formed on the recording medium is read on a condition that the conveyance speed of the conveyor detected by the speed detector has become the second conveyance speed.

4. The printing apparatus according to claim 1, further comprising an emitter that emits an energy ray to the recording medium on which the image has been formed, wherein
the controller controls the conveyor, the image former, the emitter, and the image reader such that in the first step, the image is formed on the recording medium and the energy ray is emitted to the recording medium, and that in the second step, the image formed on the recording medium is read in a state in which emission of the energy ray is stopped while the recording medium is circulated and conveyed.

5. The printing apparatus according to claim 4, wherein
the controller controls the conveyor such that in the first step, the conveyance speed of the conveyor is switched from the first conveyance speed to the second conveyance speed after an entire region of the recording medium exits from an emission region of the energy ray by the emitter.

6. The printing apparatus according to claim 1, wherein
the conveyor includes:
a printing cylinder that includes, as the holder, a holding claw on an outer periphery surface side of the printing cylinder and rotates while carrying the recording medium, the holding claw holding a leading end portion of the recording medium; and
a drive source that rotates the printing cylinder.

7. The printing apparatus according to claim 4, wherein
the energy ray is an ultraviolet ray and the ink is an ultraviolet curable ink.

8. The printing apparatus according to claim 1, wherein
the image formed on the recording medium includes a pattern image used for adjustment of the image former.
